(19) United States
(12) Patent Application Publication
(10) Pub. No.: US 2008/0197313 A1
(43) Pub. Date: Aug. 21, 2008

(54) Single piece actuator housing

(75) Inventors: Diana Rubio, El Paso, TX (US); Yinko I. Grajeda, Cd. Juarez (MX); Alejandro Moreno, El Paso, TX (US)

Correspondence Address: Delphi Technologies, Inc.;Legal Staff - M/C 480-410-202, P.O. Box 5052, Troy, MI, 48007-5052, US

(73) Assignee: Delphi Technologies, Inc.

(21) Appl. No.: 11/707,609

(22) Filed: Feb. 16, 2007

(51) Int. Cl. F16K 27/00

(52) U.S. Cl. 251/324; 251/359; 251/366

(57) ABSTRACT

An actuator housing including an elongated body having a flange, an end portion and a sealing portion, wherein the elongated body, including the flange, the end portion and the sealing portion, is formed from a single and continuous piece of material.

### BACKGROUND

The present application is directed to actuators and, more particularly, single piece actuator housings.

Typical normally closed actuators have several individual components that are connected together to function as a single unit. For example, as shown in FIG. 1, a typical normally closed actuator, generally designated 10, may include the following individual components: a stop 12, a tube 14, a spring 16, a plunger 18, a flange 20, a ring 22, a back-up ring 24, and O-ring 26, a filter 28, a valve seat 30, a lip seal 32 and a lower housing 34. The lower housing 34 may interface the actuator 10 with a mounting bore (not shown) of a hydraulic modulator (not shown) of a vehicle anti-lock braking system.

A typical process for assembling actuator 10 includes multiple steps directed to achieving a high level of quality and reliability. For example, two press operations having specific distance and force controls may be employed to connect the valve seat 30 to the lower housing 34 and the lower housing 34 to the tube 14. A first laser weld operation may be employed to secure the lower housing 34 and valve seat 30 sub-assembly to the tube 14 and a second laser weld operation may be employed to connect the stop 12 to the tube 14, thereby securing the internal components (e.g., the plunger 18) within the tube 14. The external valve components, such as the flange 20, the back-up ring 22, the ring 24, the O-ring 26 and the filter 28, are individually assembled onto the actuator 10.

Such an approach permits custom design and component characteristics, including selective material properties and supplier selection. However, such an approach typically results in larger tolerance stack and variation, more component tests, controls, assembly operations and inspection points, as well as increased material, manufacturing and assembly costs.

Accordingly, there is a need for a normally closed actuator capable of being manufactured and assembled at a relatively low cost.

### SUMMARY

In one aspect, an actuator housing may include an elongated body including a flange, an end portion and a sealing portion, wherein the elongated body, including the flange, the end portion and the sealing portion, is formed from a single and continuous piece of material.

In another aspect, an actuator housing may include a monolithic body including a flange, an end portion, a sealing portion and a valve seat, wherein the monolithic body is formed by drawing a continuous piece of rigid material.

In another aspect, a normally closed actuator may include a housing including a flange, an end portion and a sealing portion formed from a single and continuous piece of material, a valve seat connected to the housing, a plunger assembly disposed within the housing, the plunger assembly including a sealing tip adapted to sealingly engage the valve seat, a stop connected to the end portion of the housing and a biasing device positioned between the stop and the plunger to urge the plunger away from the stop.

Other aspects of the disclosed single piece actuator housings and associated actuator assemblies will become apparent from the following description, the accompanying drawings and the appended claims.

### BRIEF DESCRIPTION OF THE DRAWINGS

FIG. 1 is a side elevational view, in section, of a prior art normally closed actuator including a multi-component actuator housing;

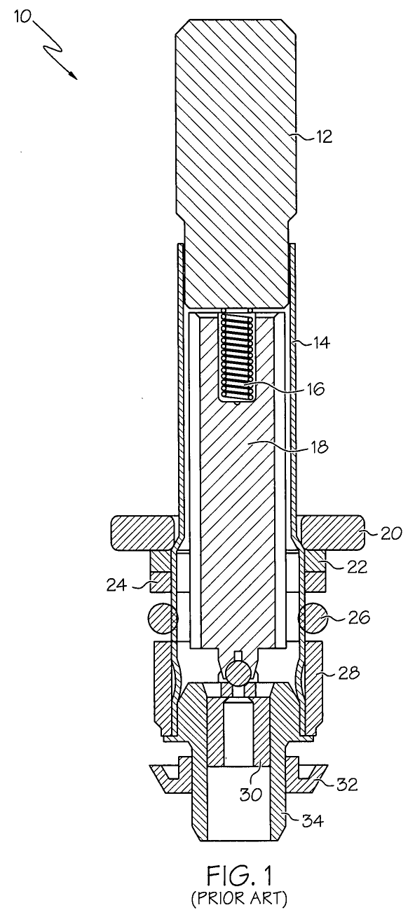

FIG. 2 is a side elevational view, in section, of a normally closed actuator including a first aspect of the disclosed single piece actuator housing; and

FIG. 3 is a side elevational view, in section, of a normally closed actuator including a second aspect of the disclosed single piece actuator housing.

### DETAILED DESCRIPTION

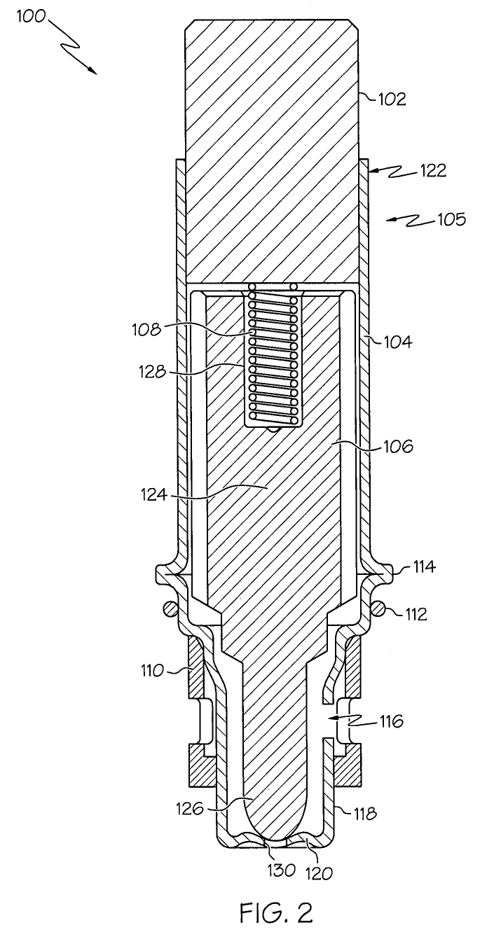

Referring to FIG. 2, a normally closed actuator according to a first aspect of the disclosure, generally designated 100, may include a stop 102, a single piece housing 104, a plunger assembly 106, a spring 108, a filter 110 and an O-ring 112 (or any elastomeric sealing material). The single piece housing 104 may include an elongated body 105 having a flange 114, an inlet hole 116, a sealing portion 118, a valve seat 120 and an end portion 122. The filter 110 may be positioned over the end portion 122 of the single piece housing 104 to filter fluid entering the housing 104 through the inlet hole 116.

The single piece housing 104 may be formed from a single, continuous piece of rigid material, such as, for example, hardened, non-magnetic steel. In one aspect, the single piece housing 104, including the flange 114, the sealing portion 118, the valve seat 120 and the end portion 122, may be formed by a drawing process. The inlet hole 116 may be formed before or after formation of the housing 104 using any available techniques, such as punching or drilling.

The flange 114 may be used to retain the actuator 100 in the modulator bore (not shown). However, the flange 114 may withstand the staking forces when the actuator 100 is secured into the modulator bore. The flange 114 or the O-ring 112 may provide a seal between the actuator 100 and the atmosphere.

The plunger assembly 106 may be formed from a magnetizable material (e.g., steel) and may include a body 124 and a sealing tip 126. In the assembled configuration shown in FIG. 2, the plunger assembly 106 may be closely and slidably received within the single piece housing 104.

The sealing tip 126 of the plunger assembly 106 may be sized and shaped to engage the valve seat 120 of the single piece housing 104 to form a generally fluid tight seal between the plunger assembly 106 and the single piece housing 104. In one aspect, the sealing tip 126 may be rounded or ball-shaped and the valve seat 120 may have a corresponding (e.g., concave) shape such that the shape of the sealing tip 126 closely aligns with the shape of the valve seat 120.

The stop 102 may be formed from a magnetizable material (e.g., steel) and may be positioned in the end portion 122 of the single piece housing 104. The stop 102 may be connected to the end portion 122 of the single piece housing 104 using any available sealing technique, such as laser welding, press fitting or the like. The stop 102 may enclose the plunger assembly 106 and the spring 108 within the single piece housing 104.

The spring 108 may be any biasing device capable of urging the sealing tip 126 of the plunger assembly 106 into engagement with the valve seat 120 of the single piece housing 104. For example, as shown in FIG. 2, the spring 108 may be a coil spring and may be positioned in a recess 128 within the plunger body 124 to urge the plunger assembly 106 away from the stop 102.

The actuator 100 may be positioned within a magnetic field by, for example, wrapping the actuator 100 with a coil (not shown). When a sufficient magnetic field is present (e.g., a current is passing through the coil) the stop 102 and plunger body 124 may become magnetized and magnetically attracted to each other. When the magnetic attraction is sufficient to overcome the biasing force of the spring 108 and hydraulic pressure forces, the plunger assembly 106 may be urged in the direction of the stop 102, thereby disengaging the sealing tip 126 from the valve seat 120 and creating a fluid flow path from the fluid inlet hole 116 into the single piece housing 104 and exiting through an outlet hole 130 in the valve seat 120. When the magnetic field ceases, the spring 108 may urge the plunger assembly 106 away from the stop 102 such that the sealing tip 126 re-engages the valve seat 120 and obstructs the fluid flow path.

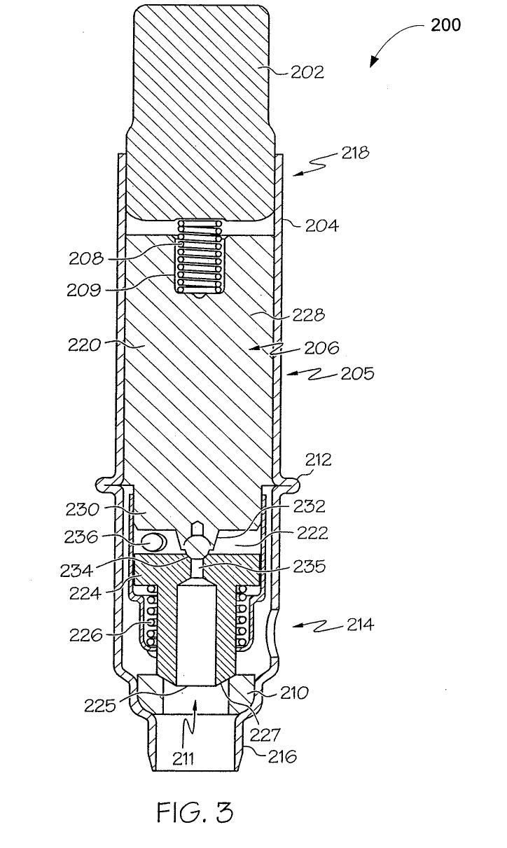

Referring to FIG. 3, a normally closed actuator according to a second aspect of the disclosure, generally designated 200, may include a stop 202, a single piece housing 204, a plunger assembly 206, a spring 208 and a valve seat 210. Though not shown in FIG. 3, the actuator 200 may also include a filter and an O-ring that function in the manner described above. The single piece housing 204 may include an elongated body 205 having a flange 212, an inlet hole 214, a sealing portion 216 and an end portion 218.

In one aspect, the single piece housing 204, including the flange 212, the sealing portion 216 and the end portion 218, may be formed by a drawing process. The inlet hole 214 may be formed before or after formation of the housing 204 using any available techniques, such as punching or drilling.

The plunger assembly 206 may be closely and slidably positioned within the single piece housing 204 and may include a plunger 220, a cup 222, a poppet 224 and a spring 226. The plunger 220 may be formed from a magnetizable material (e.g., steel) and may include a body 228 and an engaging portion 230 having a tip 232. The poppet 224 may include a sealing tip 225 and a seat 234 adapted to be engaged by the tip 232 of the engaging portion 230 of the plunger 220. The cup 222 may include a fluid hole 236.

In the assembled configuration shown in FIG. 3, the poppet 224, spring 226 and engaging portion 230 of the plunger 220 may be positioned within the cup 222 and the tip 232 of the plunger 220 may engage the seat 234 of the poppet 224. The spring 226 may be any biasing device, such as a coil spring, and may urge the poppet 224 into engagement with the engaging portion 230 of the plunger 220.

The sealing tip 225 of the poppet 224 may be sized and shaped to engage the valve seat 210 to form a generally fluid tight seal between the poppet 224 and the valve seat 210. In one aspect, the sealing tip 225 may include a rounded end 227 or a chamfer adapted to closely mate with the valve seat 210.

The valve seat 210 may be formed from a hardened material, such as hardened steel, and may be sized and shaped to closely engage the sealing tip 225 of the poppet 224. For example, the valve seat 210 may be formed by a precision machining process. In one aspect, the valve seat 210 may be press fit into the sealing portion 216 of the single piece housing 204.

The stop 202 may be formed from a magnetizable material (e.g., steel) and may be positioned in the end portion 218 of the single piece housing 204. The stop 202 may be connected to the end portion 218 of the single piece housing 204 using any available sealing technique, such as laser welding, press fitting or the like. The stop 202 may enclose the plunger assembly 206, the spring 208 and the valve seat 210 within the single piece housing 204.

The spring 208 may be any biasing device capable of urging the plunger assembly 206 into engagement with the valve seat 210. For example, as shown in FIG. 3, the spring 208 may be a coil spring and may be positioned in a recess 209 within the plunger 220 of the plunger assembly 206 to urge the plunger 220 away from the stop 202.

The actuator 200 may be positioned within a magnetic field by, for example, wrapping the actuator 200 with a coil (not shown). When a sufficient magnetic field is present (e.g., a current is passing through the coil) the stop 202 and plunger 220 may become magnetized and magnetically attracted to each other. When the magnetic attraction is sufficient to overcome the biasing force of the spring 208, the plunger 220 may be urged in the direction of the stop 202, thereby disengaging the tip 232 of the plunger 220 from the seat 234 of the poppet 224 and creating a flow path from the inlet hole 214 in the housing 204, through the fluid hole 236 in the cup 222, through a flow channel 235 in the seat 234 of the poppet 224, and exiting through an outlet hole 211 in the valve seat 210. As the pressure within the cup 222 equalizes, the spring 226 may urge the poppet 224 away from the valve seat 210, thereby creating a high flow path from the inlet hole 214 in the housing 204 directly to the outlet hole 211 in the valve seat 210. When the magnetic field ceases, the spring 208 may urge the plunger assembly 206 away from the stop 202 such that the tip 232 of the plunger 220 re-engages the seat 234 of the poppet 224 and the sealing tip 225 of the poppet 224 re-engages the valve seat 210, thereby obstructing the fluid flow paths through the outlet hole 211 of the valve seat 210.

Accordingly, the disclosed actuators 100, 200 and associated single piece housings 104, 204 may provide, among other things, (1) a high pressure seal to the modulator, (2) a valve seat area that may be coined to assure a tight ball seal, (3) a hardened valve seat for durability and structural integrity, (4) side pierced fluid passages for providing inlet and/or control flow, (5) a drawn and heat treated structure that is compatible with laser welding, (6) replacement of multiple components with a single deep drawn component, (7) an integrated flange feature that provides staking without the use of an additional flange, a means for a stake to seal (or stake and O-ring seal) that will isolate the actuator from the atmosphere and a means to retain the valve in the modulator and creates an O-ring gland or cavity that will be occupied with an O-ring that will seal the actuator from the atmosphere, (8) reduced dimensional stack providing improved internal valve component alignment, resulting in less solenoid valve performance variation, and (9) an integrated flange feature that maintains its structural integrity to prevent stroke loss resulting in valve solenoid performance failure.

Thus, those skilled in the art will appreciate that the discloses single piece actuator housings may be modified to comply with various actuator designs, while reducing material and manufacturing costs.

Although various aspects of the disclosed single piece actuator housing have been shown and described, modifications may occur to those skilled in the art upon reading the specification. The present application includes such modifications and is limited only by the scope of the claims.

What is claimed is:

1. An actuator housing comprising an elongated body and a valve seat, said elongated body including a flange, an end portion and a sealing portion, said flange being formed as a fold in said elongated body, wherein said valve seat is received within said elongated body between said end portion and said sealing portion, and wherein said elongated body, including said flange, said end portion and said sealing portion, is formed from a single and continuous piece of material.

2. The housing of claim 1 wherein said single and continuous piece of material is a rigid material.

3. The housing of claim 1 wherein said elongated body defines a fluid passage.

4. The housing of claim 1 wherein said end portion is sized and shaped to receive a stop therein.

5. The housing of claim 1 wherein said sealing portion is sized and shaped to engage a modulator bore of a hydraulic modulator.

6. The housing of claim 1 wherein said elongated body is formed by a drawing process.

7-8. (canceled)

9. The housing of claim 1 wherein said valve seat is press fit into said elongated body.

10-20. (canceled)
